(19) United States
(12) Patent Application Publication
(10) Pub. No.: US 2005/0167877 A1
(43) Pub. Date: Aug. 4, 2005

(54) Injection molded body having self-cleaning properties, and method for producing injection molded bodies of this type

(75) Inventors: Edwin Nun, Billerbeck (DE); Gernot Dambacher, Shanghai (CN); Bernhard Schleich, Recklinghausen (DE); Markus Oles, Hattingen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: CREAVIS GESELLSCHAFT F. TECHN. U. INNOVATION MBH, Marl (DE)

(21) Appl. No.: 10/506,604

(22) PCT Filed: Feb. 5, 2003
(86) PCT No.: PCT/EP03/01114

(30) Foreign Application Priority Data
Mar. 12, 2002 (DE) 102 10 673.8

(51) Int. Cl. B29C 45/14; B28B 7/22

(52) U.S. Cl. 264/143; 264/255; 264/279

(57) ABSTRACT

The invention relates to injection moldings with surfaces which have self-cleaning properties, and also to a simple process for producing the self-cleaning surfaces. The process of the invention is very simple, since it can make use of currently available equipment. Injection molded parts are usually produced by means of injection molds into which the material is injected. The process of the invention makes use of this process in that prior to the actual injection-molding process microparticles are applied to the injection mold and, during the injection-molding process, are transferred to the injection-molded part in that the particles are pressed into the surface of the injection-molded part. The process of the invention gives access to self-cleaning surfaces which have particles with a fissured structure, without any need to apply an additional emboss layer or foreign-material backing layer to the molding. Injection moldings of the invention may be three-dimensional articles of almost any type.

The invention relates to injection moldings with self-cleaning surfaces and to a process for their production.

There are various surface-treatment processes known from surface technology with give surfaces dirt-repellency and water-repellency properties. For example, it is known that in order to achieve good self-cleaning properties for a surface, the surface not only has to be hydrophobic but also has to have a certain roughness. A suitable combination of structure and hydrophobic properties makes it possible for even small amounts of water moving on the surface to entrain adherent dirt particles and clean the surface (WO 96/04123; U.S. Pat. No. 33,540,222, C. Neinhuis, W. Barthlott, Annals of Botany 79, (1997), 667).

Although he did not recognize the self-cleaning process, A. A. Abramson in Chimia i Shisn russ. 11, 38, described as early as 1982 the roll-off of water droplets from hydrophobic surfaces, especially those with structuring.

The prior art in relation to self-cleaning surfaces is that, according to EP 0 933 388, an aspect ratio greater than 1 and surface energy less than 20 mN/m are required for these self-cleaning surfaces. The aspect ratio is defined here as the average height divided by the average width of the structure. The abovementioned criteria are found in nature, for example in the lotus leaf. The plant surface formed from a hydrophobic, waxy material has elevations whose separation from one another is up to a few μm. Water droplets essentially come into contact only with the peaks of the elevations. There are many descriptions of these water-repellent surfaces in the literature. An example here is an article in Langmuir 2000, 16, 5754, by Masashi Miwa et al, describing the increase in contact angle and roll-off angle with increasing structuring of artificial surfaces formed from boehmite applied to a spin-coated lacquer layer and then calcined.

The Swiss Patent Specification CH 268258 describes a process in which structured surfaces are generated by applying powders, such as kaolin, talc, clay, or silica gel. The powders are secured to the surface by oils and resins based on organosilicon compounds.

It is known that hydrophobic materials, such as perfluorinated polymers, can be used to produce hydrophobic surfaces. DE 197 15 906 A1 describes the use of perfluorinated polymers, such as polytetrafluoroethylene, or copolymers made from polytetrafluoroethylene with perfluorinated alkyl vinyl ethers. To generate hydrophobic surfaces which have structuring and have low adhesion to snow and ice. JP 11171592 describes a water-repellent product and its production, the dirt-repellent surface being produced by applying, to the surface to be treated, a film which comprises fine particles made from metal oxide and comprises the hydrolysate of a metal alkoxide and, respectively, of a metal chelate. To secure this film, the substrate to which the film has been applied has to be sintered at temperatures above 400° C. This process is therefore useful only for substrates which can be heated to temperatures above 400° C.

The processes conventionally used hitherto for producing self-cleaning surfaces are complicated and in many cases have only limited usefulness. For example, embossing techniques are an inflexible method of applying structures to three-dimensional bodies of varying shapes. There is still currently no suitable technology for generating flat coating films of large surface area. A disadvantage of processes in which structure-forming particles are applied to surfaces by means of a carrier—e.g. an adhesive—is that the resultant surfaces are composed of a great variety of combinations of materials which, for example, have different coefficients of thermal expansion, the possible result being damage to the surface.

It was therefore an object of the present invention to provide a process for producing self-cleaning surfaces on three-dimensional moldings. The maximum simplicity of technology should be used here, and the self-cleaning surfaces should be durable.

Surprisingly, it has been found that when hydrophobic, nanostructured particles are applied to the inner mold surface of an injection mold, and an injection-molded part is then injection molded in this injection mold, the particles can become incorporated securely on the surface of the injection molding.

The present invention provides injection moldings with at least one surface which has self-cleaning properties, the surface of these moldings having at least one securely anchored layer of microparticles which form elevations.

The present invention also provides a process for producing injection moldings of the invention with at least one surface which has self-cleaning properties and which has elevations formed by microparticles, where the process comprises applying microparticles, prior to an injection-molding step, to the inner mold surface of an injection mold, and then carrying out, in this injection mold, an injection-molding process in which the microparticles are pressed into the surface of the injection molding.

The present invention also provides vessels, housings, semifinished products, protective sheets, holders, or lampshades with a surface which has self-cleaning properties and has surface structures with elevations, produced by the process of the invention.

An advantage of the process of the invention is that it can use existing equipment for the production of injection moldings. Injection molded parts are usually produced by means of injection molds into which the material is injected. The process of the invention makes use of this process in that prior to the actual injection-molding process microparticles are applied to the injection mold and, during the injection-molding process, are transferred to the injection-molded part in that the particles are pressed into the surface of the injection-molded part. This very simple method gives access to injection moldings which have self-cleaning surfaces which have particles with a fissured structure, without any need to apply an additional emboss layer or foreign-material backing layer to the injection moldings.

An advantage of the invention moldings of the invention is that structure-forming particles are not secured by a carrier material, and therefore there is no need for a large number of combinations of material and the adverse properties associated therewith.

The process of the invention gives access to self-cleaning injection moldings in which the self-cleaning effect is not achieved by applying additional material to secure the particles or to an additional chemical process.

Another advantage of the process of the invention is that surfaces susceptible to scratching are not damaged by subsequent mechanical application of a backing layer and/or of particles.

A circumstance which has proven very particularly advantageous is that self-cleaning properties can be provided on surfaces of any desired dimensions capable of production by an injection-molding process.

Another advantage is the demoldability of fine-structured moldings. This cannot always be ensured when structured molds are used.

The invention is described below by way of example, but is not restricted to these embodiments.

In the injection moldings of the invention with at least one surface which has self-cleaning properties, the surface has at least one securely anchored layer of microparticles which form elevations. A combination of the elevations present on at least part of the surface of the molding and hydrophobic properties ensures that these regions of the surfaces are of only low wettability and therefore have self-cleaning properties. The manner of obtaining the securely anchored layer of microparticles is that, prior to the injection-molding process, microparticles are applied in the form of a layer to the injection mold, and this mold is then used for injection molding. During the injection-molding process, at least some of the microparticles are pressed into the injection-molding melt, and, when the injection-molding melt solidifies, are firmly held thereby and thus anchored, giving a particularly stable anchoring if the microparticles used have a fine structure on the surface, since the fine structure is partially filled by the injection-molding melt and many anchoring sites are present after solidification of the injection-molding melt. For the purposes of the present invention, a layer of microparticles is an assembly of microparticles which form elevations on the surface. The structure of the layer may be such that the surface exclusively has microparticles, or almost exclusively has microparticles, or else has microparticles whose separation from one another is from 0 to 10 particle diameters, in particular from 0 to 3 particle diameters.

The surfaces of the injection moldings with self-cleaning properties preferably have at least one layer with elevations with an average height of from 20 nm to 25 μm and with an average separation of from 20 nm to 25 μm, preferably with an average height of from 50 nm to 10 μm and/or to an average separation of from 50 nm to 10 μm, and very particularly preferably with an average height of from 50 nm to 4 μm and/or with an average separation of from 50 nm to 4 μm. The injection moldings of the invention very particularly preferably have surfaces with elevations with an average height from 0.25 to 1 μm and with an average separation of from 0.25 to 1 μm. For the purposes of the present invention, the average separation of the elevations is the separation between the highest elevation of one elevation and the adjacent highest elevation. If the elevation has the shape of a cone, the peak of the cone is the highest elevation of the elevation. If the elevation is a rectangular parallelepiped, the uppermost surface of the parallelepiped is the highest elevation of the elevation.

The wetting of bodies, and therefore their self-cleaning property, can be described via the angle of contact made by a water droplet with the surface. An angle of contact of 0 degree here means complete wetting of the surface. The static angle of contact is generally measured using equipment in which the angle of contact is determined optically. Static contact angles below 125° are usually measured on smooth hydrophobic surfaces. The present injection moldings with self-cleaning surfaces have static contact angles preferably above 130°, with preference above 140°, and very particularly preferably above 145° C. In addition, it has been found that a surface has good self-cleaning properties only when it exhibits a difference of not more than 10° between advancing and receding angle, and for this reason surfaces of the invention preferably have a difference less than 10°, preferably less than 5°, and very particularly preferably less than 4°, between advancing and receding angle. To determine the advancing angle, a water droplet is placed on the surface by means of a cannula and the droplet is enlarged on the surface by adding water through the cannula. During enlargement, the margin of the droplet glides over the surface, and the contact angle determined is the advancing angle. The receding angle is measured on the same droplet, but water is removed from the droplet through the cannula, and the contact angle is measured during reduction of the size of the droplet. The difference between the two angles is termed hysteresis. The smaller the difference, the smaller the interaction of the water droplet with the surface of the substrate, and therefore the better the lotus effect.

The aspect ratio for the elevations of the surfaces of the invention with self-cleaning properties is preferably greater than 0.15. The elevations, which are formed by the particles themselves, preferably have an aspect ratio of from 0.3 to 0.9, particularly preferably from 0.5 to 0.8. The aspect ratio is defined here as the value calculated by dividing the maximum height by the maximum width of the structure of the elevations.

In the injection moldings of the invention with surfaces which have self-cleaning properties and have surface structures with elevations, the surfaces are preferably synthetic polymer surfaces into which particles have been directly incorporated or directly anchored, and have not been bonded via carrier systems or the like.

The particles are bonded or anchored to the surface in that the particles are pressed into the material of the injection molding during the injection-molding process. An advantageous method of achieving the aspect ratios mentioned is that at least some of the particles, preferably more than 50% of the particles, are preferably pressed into the surface of the injection molding only to the extent of 90% of their diameter. The surface therefore preferably has particles which have been anchored in the surface using from 10 to 90%, preferably from 20 to 50%, and very particularly preferably from 30 to 40%, of their average particle diameter, and parts of whose inherently fissured surface therefore still protrude from the injection-molded parts. This method ensures that the actual elevations formed by the particles have a sufficiently large aspect ratio, preferably at least 0.15. This method also achieves a very lasting bond between the securely bonded particles and the surface of the molding. The aspect ratio here is defined as the ratio of maximum height to maximum width of the elevations. According to this definition, the aspect ratio for a particle assumed to be ideally spherical and projecting to an extent of 70% from the surface of the injection molding is 0.7. It should be expressly pointed out that the particles of the invention do not have to have spherical shape.

The microparticles securely bonded to the surface and forming the elevations on the surface of the injection moldings have preferably been selected from the group consisting of silicates, minerals, metal oxides, metal powders, silicas, pigments, and polymers, very particularly preferably from the group consisting of fumed silicas, precipitated silicas, aluminum oxide, mixed oxides, doped silicates, titanium dioxides, and pulverulent polymers.

Preferred microparticles have a diameter of from 0.02 to 100 μm, particularly preferably from 0.1 to 50 μm, and very particularly preferably from 0.1 to 30 μm. However, suitable microparticles may also have a diameter below 500 nm, or be formed by accretion of primary particles to give agglomerates or aggregates with a size of from 0.2 to 100 μm.

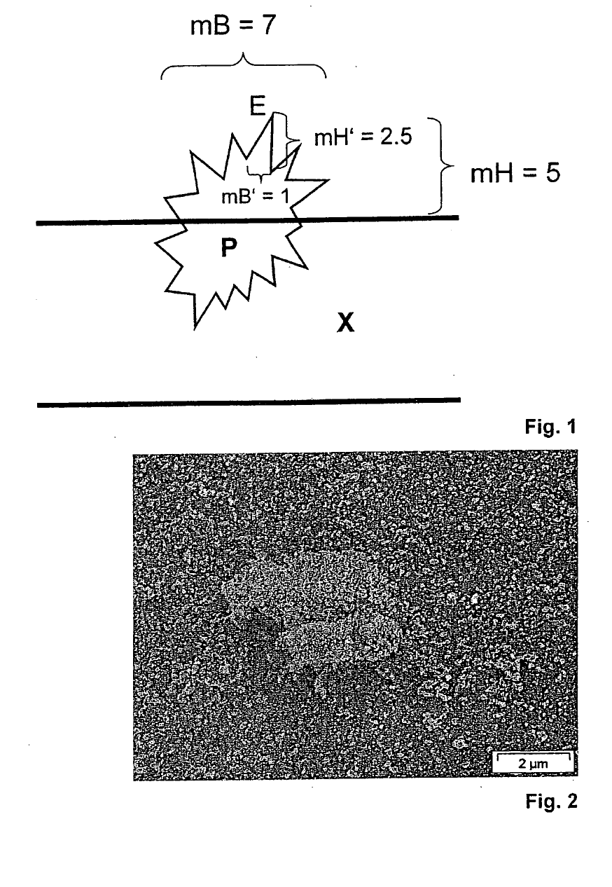

Particularly preferred microparticles which form the elevations of the structured surface are those whose surface has an irregular, slightly fissured nanostructure. These microparticles with the irregular, slightly fissured fine structure preferably have elevations with an aspect ratio in the fine structures greater than 1, particularly preferably greater than 1.5. Again, the aspect ratio is defined as the maximum height divided by the maximum width of the elevation. FIG. 1 gives an illustrative diagram of the difference between the elevations formed by the particles and the elevations formed by the fine structure. The figure shows the surface of an injection molding X, which has particles P (only one particle being depicted in order to simplify the presentation). The elevation formed by the particle itself has an aspect ratio of about 0.71, calculated as the maximum height of the particle mH, which is 5, since only that part of the particle which protrudes from the surface of the injection molding X contributes to the elevation, divided by the maximum width mB, which in turn is 7. A selected elevation of the elevations E present on the particles by virtue of their fine structure has an aspect ratio of 2.5, calculated by dividing the maximum height of the elevation mH′, which is 2.5, by the maximum width mB′, which in relation to it is 1.

Preferred microparticles whose surface has an irregular nanostructure are those particles which comprise at least one compound selected from the group consisting of fumed silica, precipitated silicas, aluminum oxide, mixed oxides, doped silicates, titanium dioxides, and pulverulent polymers.

It can be advantageous for the microparticles to have hydrophobic properties, which may be attributable to the properties of the material present on the surfaces of the particles, or else may be obtained by treating the particles with a suitable compound. The microparticles may be provided with hydrophobic properties prior to or after application or bonding to the surface of the injection molding.

To hydrophobicize the particles prior to or after application to the surface, they may be treated with a compound suitable for hydrophobicization, e.g. selected from the group consisting of the alkylsilanes, the fluoroalkylsilanes, and the disilazanes.

Particularly preferred microparticles are described in more detail below. The particles may be derived from various fields. For example, they may be silicates, doped silicates, minerals, metal oxides, aluminum oxide, silicas, or titanium dioxides, Aerosils®, or pulverulent polymers, e.g. spray-dried and agglomerated emulsions, or cryogenically milled PTFE. Particularly suitable particle systems are hydrophobicized fumed silicas, known as Aerosils®. To generate the self-cleaning surfaces, hydrophobic properties are needed alongside the structure. The particles used may themselves be hydrophobic, for example pulverulent polytetrafluoroethylene (PTFE). The particles may have been given hydrophobic properties, for example Aerosil VPR 411® or Aerosil R 8200®. However, they may also be hydrophobicized subsequently. It is unimportant here whether the particles are hydrophobicized prior to application or after application. Examples of these particles which have to be hydrophobicized are Aeroperl 90/30®, Sipernat silica 350®, aluminum oxide C®, zirconium silicate, vanadium-doped or VP Aeroperl P 25/20®. In the case of the latter, it is advantageous for the hydrophobicization to take place by treatment with perfluoroalkylsilane compounds followed by heat-conditioning.

The injection moldings may have the elevations on all surfaces or only on certain surfaces, or on subregions of these. The injection moldings of the invention preferably have the elevations on all surfaces.

The material of the injection moldings themselves may preferably comprise polymers based on polycarbonates, on polyoxymethylenes, on poly(meth) acrylates, on polyamides, on polyvinyl chloride (PVC), on polyethylenes, on polypropylenes, on polystyrenes, on polyesters, on polyether sulfones, on aliphatic linear or branched polyalkenes, on cyclic polyalkenes, on polyacrylonitrile, or on polyalkylene terephthalates, or else comprise their mixtures or copolymers. The material present in the injection moldings is particularly preferably a material selected from the group consisting of poly(vinylidene fluoride), poly(hexafluoropropylene), poly(perfluoropropylene oxide), poly(fluoroalkyl acrylate), poly(fluoroalkyl methacrylate), polyvinyl(perfluoroalkyl ether) or is another polymer selected from the group consisting of perfluoroalkoxy compounds, poly(ethylene), poly(propylene), poly(isobutene), poly(4-methyl-1-pentene), or polynorbornene in the form of homo- or copolymer. The material for the surface of the injection moldings is particularly preferably poly(ethylene), poly(propylene), polymethyl methacrylates, polystyrenes polyesters, acrylonitrile-butadiene-styrene terpolymers (ABS), or poly(vinylidene fluoride).

The injection moldings of the invention are preferably produced by the process of the invention for producing injection moldings with at least one surface which has self-cleaning properties and has elevations formed by microparticles, the process comprising the application of microparticles, prior to an injection-molding step, to the inner surface of the injection mold, and then the carrying-out of an injection-molding step in which the microparticles are pressed into the surface of the injection molding. The injection mold is preferably a mold which is usually used for the production of conventional injection moldings. These conventional injection moldings may, for example, be composed of two parts, the cavity plate and the core. According to the process of the invention, the microparticles may be applied to the cavity plate and/or to the core.

The preferred manner of impression is that at least a portion of the particles, preferably at least 50% of the particles, are pressed to an extent of not more than 90% of their diameter, preferably using from 10 to 70%, with preference using from 20 to 50%, and very particularly preferably using from 30 to 40%, of their average particle diameter, into the surface of the injection molding.

The material used for the process of the invnetion may be any of the polymers suitable for producing injection moldings by the injection-molding process. Preferred materials used for the injection-molding process are polymers which comprise a polymer based on polycarbonates, on polyoxymethylenes, on poly(meth)acrylates, on polyamides, on polyvinyl chloride, on polyethylenes, on polypropylenes, on aliphatic linear or branched polyalkylenes, on cyclic polyalkenes, on polystyrenes, on polyesters, on polyether sulfones, on polyacrylonitrile, or on polyalkylene terephthalates, on poly(vinylidene fluoride), on poly(hexafluoropropylene), on poly(perfluoropropylene oxide), on poly(fluoroalkyl acrylate), on poly(fluoroalkyl methacrylate), on poly(vinyl perfluoroalkyl ether), or comprise other polymers made from perfluoroalkoxy compounds, poly(isobutene), ABS, poly(4-methyl-1-pentene), polynorbornene in the form of homo- or copolymer, or a mixture of these.

The microparticles which are pressed into the surface of the injection molding in the process of the invention are applied to the surface of the injection mold prior to the substep of impression via an injection-molding process. The application preferably takes place by spraying. The application of the microparticles to the injection mold is particularly advantageous because the micropowder inhibits adhesion of the material of the injection molding to the mold once the injection-molding procedure has ended, since the material itself makes no, or hardly any, contact with the mold, because in order to achieve the preferred separations of the elevations, the microparticles are applied to the mold in a very compact manner.

Examples of methods of spray-application of the microparticles to the mold are spray-application of microparticle-powder-containing aerosols or dispersions which, besides the microparticles, comprise a propellant or a preferably highly volatile solvent, preference being given to spray-application from suspensions. The solvent preferably present in the suspensions used is an alcohol, in particular ethanol or isopropanol, ketones, e.g. acetone or methyl ethyl ketone, ethers, e.g. diisopropyl ether, or else hydrocarbons, such as cyclohexane. The suspensions particularly preferably comprise alcohols. It can be advantageous for the suspension to comprise from 0.1 to 10% by weight, preferably from 0.25 to 7.5% by weight, and very particularly preferably from 0.2 to 5% by weight, of microparticles, based on the total weight of the suspension. In particular in the case of spray-application of a dispersion, it can be advantageous for the injection mold to have a mold surface temperature of from 30 to 150° C. Depending on the injection molding to be produced or on the material used therefor, however, the temperature of the mold may also be in the range mentioned irrespective of the microparticle powder or the application of the microparticle powder.

The pressure with which the material is injected into the injection mold is preferably greater than 40 bar, but, like other parameters to be considered during the injection-molding process, depends on factors such as the temperature, the nature of the polymer used for the injection-molding process, the design of the injection mold, (e.g. in the form of a hot-runner mold) and also on the geometry used for the injection-molded part. The determination of the parameters for the injection-molding process is within the knowledge possessed by the skilled worker and is not described in further detail here. Examples of information relating to the injection-molding process can be referred to in Hans Batzer, Polymere Werkstoffe [Polymer materials], Georg Thieme Verlag Stuttgart—New York, 1984 or in Kunststoff Handbuch 1, Die Kunststoffe; Chemie, Physik, Technologie [Plastics Handbook 1, The Polymers; Chemistry, Physics, Technology], Bodo Carlowitz (Editor), Hanser Verlag Munich, 1990.

The microparticles preferably used in the process of the invention are those which comprise at least one material selected from the group consisting of silicates, minerals, metal oxides, metal powders, silicas, pigments, and polymers. It is preferable to use microparticles whose diameter is from 0.02 to 100 μm, particularly preferably from 0.1 to 15 μm, and very particularly preferably from 0.1 to 30 μm. It is also possible to use microparticles with diameters below 500 nm. However, other suitable microparticles are those accreted from primary particles to give agglomerates or aggregates with a size of from 0.2 to 100 μm.

The microparticles used, in particular the particles -whose surface has an irregular fine nanostructure, are particles which comprise at least one compound selected from the group consisting of fumed silica, precipitated silicas, aluminum oxide, mixed oxides, doped silicates, titanium dioxides, and pulverulent polymers. Preferred particles whose surface has an irregular fine nanostructure have, within this fine structure, elevations whose aspect ratio is greater than 1, particularly preferably greater than 1.5, and very particularly preferably greater than 2.5. Again, the aspect ratio is defined as the maximum height divided by the maximum width of the elevation.

The microparticles preferably have hydrophobic properties, which may be attributable to the properties of the materials present on the surfaces of the particles, or else be obtained by treating the particles with a suitable compound. The particles may be provided with hydrophobic properties prior to or after the process of pressing into the surface.

For the hydrophobicization of the microparticles prior to or after the process of pressing (anchoring) into the surface of the injection molding, these may be treated with a compound suitable for hydrophobicization, e.g. one selected from the group consisting of the alkylsilanes, the fluoroalkylsilanes, and the disilazanes, for example as supplied under the name Dynasylan by Degussa AG.

The microparticles whose use is preferred are described in more detail below. The particles used may come from a variety of sectors. For example, they may be titanium dioxides, doped silicates, minerals, metal oxides, aluminum oxide, silicas, fumed silicates, Aerosils®, pulverulent polymers, e.g. spray-dried and agglomerated emulsions, or cryogenically milled PTFE. Particularly suitable particle systems are hydrophobicized fumed silicas, known as Aerosils. To generate the self-cleaning surfaces, hydrophobic properties are needed alongside the structure. The particles used may themselves be hydrophobic, for example PTFE. The particles may have been provided with hydrophobic properties, for example Aerosil VPR 411® or Aerosil R 8200®. However, they may also be hydrophobicized subsequently. It is unimportant here whether the particles are hydrophobicized prior to application or after application. Examples of these particles which have to be hydrophobicized are Aeroperl P 90/30®, Sipernat silica 350®, aluminum oxide C®, zirconium silicate, vanadium-doped or VP Aeroperl P 25/20®. In the case of the latter, it is advantageous for the hydrophobicization to take place by treatment with perfluoroalkylsilane compounds followed by heat-conditioning.

The process of the invention gives access to three-dimensional moldings with a surface which has self-cleaning properties and has surface structures with elevations. The moldings may have any conceivable shape which can be produced using the known injection-molding process. These moldings may in particular be vessels for receiving liquids or pastes. In particular, these moldings may have been selected from the group consisting of vessels, lampshades, bins, storage vessels, drums, dishes, measuring beakers, funnels, tanks, and housing parts.

The process of the invention is described using FIGS. 1 and 2, but there is no intention that the invention be restricted thereto. FIG. 1 shows a diagram of the surface of an injection molding X, which comprises particles P. (Only one particle has been depicted, in order to simplify the presentation.) The elevation formed by the particle itself has an aspect ratio of about 0.71, calculated as the maximum height of the particle mH, which is 5, since only that part of the particle which protrudes from the surface of the injection molding X contributes to the elevation, divided by the maximum width mB, which in turn is 7. A selected elevation of the elevations E present on the particles by virtue of their fine structure has an aspect ratio of 2.5, calculated by dividing the maximum height of the elevation mH′, which is 2.5, by the maximum width mB′, which in relation to it is 1.

FIG. 2 depicts a scanning electron micrograph (SEM) of an injection molding coated with hydrophobic Aerosil 8200 silica and produced as in Example 1. It can easily be seen that the silica particles have been anchored within the surface. In the centre of the figure, two large silica particle aggregates can be seen. However, there are also other particles with sizes of about 200 nm to be seen on the surface.

The process of the invention is described using the examples below, but there is no intention that the invention be restricted to this embodiment.

### EXAMPLE 1

A suspension of Aerosil R8200® (1% strength by weight in ethanol) is applied to an injection mold, and the solvent (ethanol) is then allowed to evaporate. Using the injection mold thus prepared, round plaques of diameter 6 cm and thickness 2 mm were injection molded from impact-modified PVC (Vinnolit S3268 with K value 68, impact-modified using about 6% of Barodur EST 4) with a mold surface temperature of 60° C. and a pressure of 55 bar, using a standard injection-molding machine (Engel 150/50 S). The melt temperature was 195° C., and the hold pressure was 50 bar. The injection molding obtained from the injection mold comprised particles pressed into the surface. The roll-off angle for a water droplet on the resultant surface of the injection molding was determined by applying a droplet to the surface and constantly increasing the inclination of the injection molding in order to determine the angle at which the droplet rolls off from the surface. A roll-off angle of 8.6° and a contact angle of about 150° were found for a water droplet of size 40 μl.

### EXAMPLE 2

As in example 1, round plaques were produced from other plastics by injection molding, using the plastics given in table 1 below and the parameters there given. Unlike in example 1, the round plaques produced had diameter 60 mm and thickness 4 mm. Prior to each injection-molding step, in each case a suspension of Aerosil R8200®, 1% strength by weight in ethanol, was applied to the injection mold, and the solvent was then allowed to evaporate.

TABLE 1

| | | | | | Injection | Hold | Hold | Cooling | Injection |
|---|---|---|---|---|---|---|---|---|---|
| | | | Melt | Mold | pressure | pressure | pressure | time | time |
| Product | Plastic | Full name | (° C.) | (° C.) | (bar) | (bar) | (sec) | (sec) | (sec) |
| VESTAMID | PA 12 | Polyamide | 200 | 50 | 90 | 30 | 10 | 20 | 6.2 |
| L1600 | | | | | | | | | |
| VESTAMID | PA 12 | Polyamide | 250 | 60 | 90 | 30 | 16 | 20 | 5.06 |
| D16 | | | | | | | | | |
| VESTODUR | PBT | Polybutylene | 260 | 60 | 90 | 20 | 16 | 15 | 2.81 |
| 1000 | | terephthalate | | | | | | | |
| TROGAMID | PA 6-3T | Polyamide, | 280 | 80 | 90 | 35 | 16 | 16 | 3.61 |
| T5000 | | transparent | | | | | | | |
| VESTORAN | PPE | Polyphenylene | 300 | 80 | 90 | 35 | 16 | 15 | 3.36 |
| 1900 | | ether | | | | | | | |
| DYFLOR | PVDF | Polyvinylidene | 270 | 80 | 90 | 35 | 16 | 15 | 2.76 |
| LE | | fluoride | | | | | | | |

Again, the roll-off angle was determined for the resultant round plaques for a 40 μl water droplet, as in example 1. In addition, advancing and receding angle were measured optically. To determine the advancing angle, a water droplet is placed on the surface by means of a cannula and the droplet is enlarged on the surface by adding water through the cannula. During enlargement, the margin of the droplet glides over the surface, and the contact angle determined is the advancing angle. The receding angle is measured on the same droplet, but water is removed from the droplet through the cannula, and the contact angle is measured during reduction of the size of the droplet. The difference between the two angles is termed hysteresis. The smaller the difference, the smaller the interaction of the water droplet with the surface of the substrate, and therefore the better the lotus effect. In our experiments, surfaces only have good self-cleaning properties if they have a difference of not more than 10° between advancing angle and receding angle. The results are given in table 2. For comparison, table 2 also gives the roll-off angle of water droplets of 40 μl for round plaques which were obtained by the above injection-molding process with no use of microparticles.

TABLE 2

| | | | | | | Roll-off angle |
|---|---|---|---|---|---|---|
| | | | Roll-off | | | for an |
| | | | angle (°) | | | unstructured |
| | | | 40 μl | Advancing | Receding | round plaque |
| Product | Plastic | Full name | droplet | angle (°) | angle (°) | (°) |
| VESTAMID | PA 12 | Polyamide | 0.7 | 156.1 | 154.9 | 31.7 |
| L1600 | | | | | | |
| VESTAMID | PA 12 | Polyamide | 1.4 | 155.1 | 152.9 | 49.0 |
| D16 | | | | | | |
| VESTODUR | PBT | Polybutylene | 1.6 | 151.6 | 147.0 | 31.8 |
| 1000 | | terephthalate | | | | |
| TROGAMID | PA 6-3T | Polyamide | 3.0 | 154.3 | 152.9 | 38.1 |
| T5000 | | transparent | | | | |
| VESTORAN | PPE | Polyphenylene | 3.0 | 156.8 | 154.7 | 29.1 |
| 1900 | | ether | | | | |
| DYFOR LE | PVDF | Polyvinylidene | 2.4 | 156.5 | 154.0 | 19.6 |
| | | fluoride | | | | |

As can clearly be seen from the results of table 2, application of microparticles to an injection mold followed by use of this mold for an injection-molding process permits the production of injection moldings which have surfaces with self-cleaning properties, i.e. surfaces from which dirt particles can easily be removed by means of water which has been set in motion.

1. An injection molding with at least one surface which has self-cleaning properties, wherein the surface has at least one securely anchored layer of microparticles which form elevations.

2. The injection molding as claimed in claim 1, wherein the elevations have an average height of from 20 nm to 25 μm and an average separation of from 20 nm to25 μm.

3. The injection molding as claimed in claim 1, wherein the elevations have an average height of from 50 nm to 4 μm and/or an average separation of from 50 nm to 4 μm.

4. The injection molding as claimed in claim 1, wherein the actual elevations formed by the particles have an aspect ratio of from 0.3 to 0.9.

5. The injection molding as claimed in claim 1, wherein the microparticles are nanostructured microparticles which have a fine structure with elevations with an aspect ratio greater than 1.

6. The injection molding as claimed in claim 1, wherein the microparticles are selected from the group consisting of particles of silicates, minerals, metal oxides, metal powders, silicas, pigments, and polymers and mixtures thereof.

7. The injection molding as claimed in claim 1, wherein the microparticles are selected from the group consisting of particles of fumed silicas, precipitated silicas, aluminum oxide, mixed oxides, doped silicates, titanium dioxide, pulverulent polymers and mixtures thereof.

8. The injection molding as claimed in claim 1, wherein the microparticles have hydrophobic properties.

9. The injection molding as claimed in claim 1, wherein the injection molding itself comprises a material selected from the group consisting of polycarbonates, polyoxymethylenes, poly(meth)-acrylates, polyamides, polyvinyl chloride, polyethylenes, polypropylenes, aliphatic linear or branched polyalkenes, cyclic polyalkenes, polystyrenes, polyesters, polyether sulfones, polyacrylonitrile, polyalkylene terephthalates, poly(vinylidene fluoride), poly(hexafluoropropylene), poly(perfluoropropylene oxide), poly(fluoroalkyl acrylate), poly(fluoroalkyl methacrylate), poly(vinyl perfluoroalkyl ether), or comprises other polymers made from perfluoro-alkoxy compounds, poly(isobutene), poly(4-methyl-1-pentene), polynorbornene in the form of homo- or copolymer, and mixtures thereof.

10. The injection molding as claimed in claim 1, wherein the impressed particles have been anchored with from 10 to 90% of their average particle diameter in the surface.

11. The rejection molding as claimed in claim 1, wherein the microparticles have an average particle size (diameter) of from 0.02 to 100 μm.

12. A process for producing injection moldings as claimed in claim 1 with at least one surface which has self-cleaning properties and has elevations formed by microparticles, by injection molding, comprising which comprises applying microparticles to the injection mold prior to an injection-molding step and then carrying out an injection-molding step in which the microparticles are pressed into the surface of the injection molding.

13. The process as claimed in claim 12, wherein at least some of the impressed particles are impressed into the injection molding only to the extent of not more than 90% of their diameter.

14. The process as claimed in claim 12 further comprising for the injection-molding process, utilizing a polymer based on polycarbonates, on polyoxymethylenes, on poly(meth)acrylates, on polyamides, on polyvinyl chloride, on polyethylenes, on polypropylenes, on aliphatic linear or branched polyalkenes, on cyclic polyalkenes, on polystyrenes, on polyesters, on polyether sulfones, on polyacrylonitrile, on polyalkylene terephthalates, on poly(vinylidene fluoride), on poly(hexafluoropropylene), on poly(perfluoropropylene oxide), on poly (fluoroalkyl acrylate), on poly(fluoroalkyl methacrylate), on poly(vinyl perfluoroalkyl ether), or of other polymers made from perfluoroalkoxy compounds, poly(isobutene), poly(4-methyl-1-pentene), acrylonitrile-butadiene-styrene terpolymer (ABS), polynorbornene in the form of homo- or copolymer, and mixtures thereof.

15. The process as claimed in claim 12, wherein the injection mold is a mold needed for the production of conventional injection moldings.

16. The process as claimed in claim 12, where the microparticles are applied to the injection mold by spray-application.

17. The process as claimed in claim 16, wherein the microparticles are applied to the injection mold by applying, to the injection mold, a suspension which comprises hydrophobic particles and comprises a solvent, and then evaporating the solvent.

18. The process as claimed in claim 16, wherein the microparticles are applied to the injection mold by applying an aerosol which comprises hydrophobic particles and a propellant gas.

19. The process as claimed in claim 12, wherein the injection-molding process is carried out using a pressure greater than 40 bar.

20. The process as claimed in claim 12, wherein the microparticles used have an average particle diameter of from 0.2 to 100 μm.

21. The process as claimed in claim 12 further comprising utilizing microparticles selected from the group consisting of silicates, minerals, metal oxides, metal powders, silicas, pigments, polymers and mixtures thereof.

22. The process as claimed in claim 12, wherein the microparticles used have hydrophobic properties.

23. The process as claimed in claim 12, wherein the microparticles have hydrophobic properties by virtue of treatment with a suitable compound.

24. The process as claimed in claim 23, wherein the microparticles have been provided with hydrophobic properties prior to or after bonding to the surface of the injection molding.

25. A molding with a surface which has self-cleaning properties and has surface structures with elevations, produced by a process as claimed in claim 12.

26. The molding as claimed in claim 25, selected from the group consisting of vessels, lampshades, bins, storage vessels, drums, dishes, measuring beakers, funnels, tanks, and housing parts.
